(19) United States
(12) Patent Application Publication
(10) Pub. No.: US 2023/0037793 A1
(43) Pub. Date: Feb. 9, 2023

(54) AIR COMPRESSING APPARATUS WITH BEARING WEAR-CAUSING THRUST REDUCING/COMPENSATING UNIT

(71) Applicant: TURBOWIN CO., LTD., Cheongju-si (KR)

(72) Inventor: Minsoo KIM, Daejeon (KR)

(73) Assignee: TURBOWIN CO., LTD., Cheongju-si (KR)

(21) Appl. No.: 17/412,981

(22) Filed: Aug. 26, 2021

(30) Foreign Application Priority Data
Aug. 9, 2021 (KR) 10-2021-0104863

(51) Int. Cl. F04D 29/051; F01D 3/04

(52) U.S. Cl. CPC F04D 29/0516; F01D 3/04; F16C 2360/44; F05D 2240/52

(57) ABSTRACT

Disclosed is an air compressing apparatus with a bearing wear-causing thrust reducing/compensating unit, and more specifically, to an air compressing apparatus with a bearing wear-causing thrust reducing/compensating unit that reduces or compensates thrust generated due to high-speed rotation of an air-compression impeller formed in the air compressing apparatus, thereby maximizing a service life and durability of the air compressing apparatus.

### BACKGROUND OF THE INVENTION

### Field of the Invention

The present invention relates to an air compressing apparatus with a bearing wear-causing thrust reducing/compensating unit, and more specifically, to an air compressing apparatus with a bearing wear-causing thrust reducing/compensating unit that reduces or compensates thrust generated due to high-speed rotation of an air-compression impeller formed in the air compressing apparatus, thereby maximizing a service life and durability of the air compressing apparatus.

### Description of the Related Art

The air compression means is a device for compressing gas (air) by rotational driving of an impeller, and is divided into a blower and a compressor according to the discharge pressure of the compressed gas (air).

Such an air compression means generates thrust due to the high-speed rotation of the impeller.

The thrust is an external force acting in the axial direction of the rotating shaft and the rotating body, which is generated due to the pressure difference between the front and rear surfaces of the rotating body, and is closely related to the life and durability of the mechanical elements of constituting the air compression means.

In other words, it is an external force generated in the front direction of the rotating body by forming a pressure on the rear surface of the rotating body as the pressure of the air rises and the air with the increased pressure leaks through the gap between the rotor and the stator when the air is sucked in and discharged through the rotating body.

At this time, among the components of the air compression means, the bearing, which is a mechanical element for supporting the load of the shaft, is an element that prevents the thrust greater than a certain standard value biased in one direction so that the shaft can rotate smoothly. The close relationship between the bearing and the thrust is an important factor determining the life and durability of the air compression means.

However, the bearing for preventing thrust greater than or equal to a certain reference value is rather in contact with and rubs against one rear surface of the impeller due to a thrust greater than or equal to the predetermined reference value applied to the air compression means, thereby shortening the life of the bearing.

Therefore, the present invention is to provide an air compression means capable of securing the life of a bearing, to which a bearing wear-causing thrust reducing/compensating unit is applied, by reducing and correcting the thrust acting on the air compression means and by minimizing the contact and friction between the impeller and the bearing.

In the meantime, as a prior art for an air compression means to which the bearing wear-causing thrust reducing/compensating unit is applied, “A compressor with a thrust reduction function” of Korean Patent Registration No. 10-1171469 (hereinafter referred to as “Patent Literature 1”) is disclosed as shown in FIG. 9A. Patent Literature 1 relates to a compressor in which an inner circumferential surface of a seal part facing an outlet end of an impeller is improved with a new structural type in order to reduce thrust due to high pressure formed in the back plate of the impeller. By inducing the pressure formed at the outlet end of the impeller to drop, all of the flow disturbance at the impeller inlet, unstable pressure change, and oil leakage through the balance hole, which occurred in the conventional structure type formed in the impeller, are solved, thereby increasing the compression efficiency and performance of the compressor.

As another prior art for an air compression means to which the bearing wear-causing thrust reducing/compensating unit is applied, “A thrust reduction compressor” of Korean Patent Publication No. 10-2017-0046433 (hereinafter referred to as “Patent Literature 2”) is disclosed as shown in FIG. 9B.

In Patent Literature 2, a thrust reducing member is joined to a shaft system of an impeller, and an air seal whose inner diameter is enlarged is coupled to the outer surface of the thrust reducing member. Accordingly, a high pressure is applied to a rear surface of the impeller from operation of a compressor, and when the thrust is applied to the shaft system due to the high pressure, the pressure is reduced to ensure operational stability of the compressor. In addition, compression efficiency of the compressor is improved while preventing friction loss between the air seal and the shaft system, and when the compressor is configured in a dual, the compressor prevents the net thrust from being diverted from a transient state, thereby improving overall operating performance of the compressor.

As described above, Patent Literatures 1 and 2 are the same technical field as the present invention and have similar and identical technical concepts in terms of the basic elements of the invention and the object of the invention for reducing the thrust in comparison with the present invention. However, there is a difference in terms of the subject matters to be solved by the invention (object of the invention).

That is, there are differences in technical characteristics in specific solutions (components) of the invention for solving the problem to be solved by the invention and exerting the effect thereof.

Accordingly, the present invention is different from the technology for reducing thrust of the conventional air compression means including the Patent Literature 1 and Patent Literature 2. Also, the present invention seeks to achieve the technical features based on the problem to be solved by the invention (object of the invention), a solution means (element) for solving it, and the effect exerted by solving the same.

### PATENT LITERATURE

Patent Literature 1: Korean Patent Registration No. 10-1171469 (Jul. 26, 2012)
Patent Literature 2: Korean Patent publication No. 10-2017-0046433 (May 2, 2017)

### SUMMARY OF THE INVENTION

The invention is made to solve the above-described problems in the related art, and an object thereof is to provide an air compressing apparatus that reduces or compensates thrust generated inside an air compressing unit due to high-speed rotation of an air-compression impeller, thereby maximizing a service life and durability of the air compressing apparatus.

In other words, the object thereof is to provide the air compressing apparatus that emits, to outside or inside, a part of air having certain pressure which generates thrust inside the air compressing unit and reduces pressure generated at one side of a rear surface of the air-compression impeller, thereby reducing or compensating the thrust and minimizing or inhibiting movement of a bearing positioned at the one side of the rear surface of the air-compression impeller toward the rear surface of the air-compression impeller and rubbing of the bearing against the rear surface due to the thrust equal to or higher than a certain threshold value.

In other words, the object thereof is to provide the air compressing apparatus that reduces thrust so as to minimize or inhibit movement of the bearing toward the rear surface of the air-compression impeller and rubbing of the bearing against the rear surface due to thrust equal to or higher than a certain threshold value, the thrust being generated inside the air compressing apparatus, thereby minimizing or inhibiting wear, friction resistance, and cracks and damage therefrom of the bearing such that a service life and durability of the bearing are maximized and thus a service life and durability of the air compressing apparatus are also maximized.

The service life and the durability of the bearing are directly related to a service life and durability of a rotor and are also directly related to the overall service life and the durability of the air compressing apparatus. Hence, the service life and the durability of the air compressing apparatus are secured by minimizing wear and friction resistance of the bearing which are generated due to the thrust equal to or higher than the threshold value.

According to an aspect of the invention to achieve the object described above, there is provided an air compressing apparatus with a bearing wear-causing thrust reducing/compensating unit, the air compressing apparatus including: an air compressing unit that suctions air from outside, compresses suctioned air, and discharges compressed air; and a bearing wear-causing thrust reducing/compensating unit that is formed at one side of the air compressing unit and causes bearing wear-causing thrust generated in the air compressing unit to be reduced or compensated such that durability of the air compressing unit is improved,

wherein the bearing wear-causing thrust is generated in an axial direction of the air compressing unit during operation of the air compressing unit,

wherein the air compressing unit is configured to include: an air-compression housing that suctions outside air, guides the suctioned outside air to flow and be discharged, and protects, from outside, an air-compression stator, an air-compression rotor, an air-compression shaft, and an air-compression impeller which are positioned and coupled inside the air-compression housing; the air-compression stator that is a stator positioned inside the air-compression housing; the air-compression rotor that is a rotor positioned inside the air-compression housing; the air-compression shaft that is coupled to the air-compression rotor and is rotated; the air-compression impeller that is coupled to the air-compression shaft and is rotated driven by rotation of the air-compression shaft to suction outside air, compress suctioned outside air, and discharge compressed air; an axial-load supporting bearing that is inserted into and coupled to the air-compression shaft to support a load in an axial direction; and an air-leak preventive chamber that is positioned between the air-compression impeller and the axial-load supporting bearing, inhibits air from leaking through a gap between the air-compression stator and the air-compression rotor, and reduces pressure of a rear surface of the air-compression impeller,

wherein power is generated to suction outside air, compress suctioned outside air, and discharge compressed air such that outside air is suctioned and compressed air is discharged,

wherein the bearing wear-causing thrust includes: a first impeller thrust element that is applied to a certain region at an outer side of the rear surface of the air-compression impeller and is generated in a first pressure generation zone having high pressure generated depending on a degree of compression of air suctioned into the air compressing unit; a second impeller thrust element that is applied to a certain region at an inner side of the rear surface of the air-compression impeller and is generated in a second pressure generation zone having pressure generated depending on a degree of compression of air suctioned into the air compressing unit; and a third impeller thrust element that is applied toward a front surface of the air-compression impeller due to rotation of the air-compression impeller,

wherein the bearing wear-causing thrust reducing/compensating unit is configured to include: a thrust reducing hole module that is formed into a certain pattern to pass through at one side of the air-leak preventive chamber, emits a part of air having certain pressure which causes the second impeller thrust element to be generated at the rear surface of the air-compression impeller, and causes the bearing wear-causing thrust generated in the air compressing unit to be reduced or compensated; a thrust external-emission guide-pipe module that has one end portion which matches and is connected to the thrust reducing hole module and the other end portion which is formed to pass to the outside through one side of the air-compression stator and that guides a part of air to be emitted to the outside, the air having certain pressure (air having certain pressure to generate the second impeller thrust element) which is emitted to the thrust reducing hole module; and a pressure external-emission thrust-reducing path module that is formed along a path connected from the thrust reducing hole module to the thrust external-emission guide-pipe module when a part of air having certain pressure (air having certain pressure to generate the second impeller thrust element) which is generated at the rear surface of the air-compression impeller is emitted outside,

wherein pressure in the second pressure generation zone is reduced such that the bearing wear-causing thrust is reduced by guiding a part of air to be emitted to the outside along the pressure external-emission thrust-reducing path module, the air having certain pressure (air having certain pressure to generate the second impeller thrust element) which is generated at the rear surface of the air-compression impeller due to high speed rotation of the air-compression impeller, and

wherein the axial-load supporting bearing is protected such that durability and a service life of the air compressing unit is maximized.

According to another aspect of the invention to achieve the object described above, there is provided an air compressing apparatus with a bearing wear-causing thrust reducing/compensating unit, the air compressing apparatus including: an air compressing unit that suctions air from outside, compresses suctioned air, and discharges compressed air; and a bearing wear-causing thrust reducing/compensating unit that is formed at one side of the air compressing unit and causes bearing wear-causing thrust generated in the air compressing unit to be reduced or compensated such that durability of the air compressing unit is improved,

wherein the bearing wear-causing thrust is generated in an axial direction of the air compressing unit during operation of the air compressing unit,

wherein the air compressing unit is configured to include: an air-compression housing that suctions outside air, guides the suctioned outside air to flow and be discharged, and protects, from outside, an air-compression stator, an air-compression rotor, an air-compression shaft, and an air-compression impeller which are positioned and coupled inside the air-compression housing; the air-compression stator that is a stator positioned inside the air-compression housing; the air-compression rotor that is a rotor positioned inside the air-compression housing; the air-compression shaft that is coupled to the air-compression rotor and is rotated; the air-compression impeller that is coupled to the air-compression shaft and is rotated driven by rotation of the air-compression shaft to suction outside air, compress suctioned outside air, and discharge compressed air; an axial-load supporting bearing that is inserted into and coupled to the air-compression shaft to support a load in an axial direction; and an air-leak preventive chamber that is positioned between the air-compression impeller and the axial-load supporting bearing, inhibits air from leaking through a gap between the air-compression stator and the air-compression rotor, and reduces pressure of a rear surface of the air-compression impeller,

wherein power is generated to suction outside air, compress suctioned outside air, and discharge compressed air such that outside air is suctioned and compressed air is discharged,

wherein the bearing wear-causing thrust includes: a first impeller thrust element that is applied to a certain region at an outer side of the rear surface of the air-compression impeller and is generated in a first pressure generation zone having high pressure generated depending on a degree of compression of air suctioned into the air compressing unit; a second impeller thrust element that is applied to a certain region at an inner side of the rear surface of the air-compression impeller and is generated in a second pressure generation zone having pressure generated depending on a degree of compression of air suctioned into the air compressing unit; and a third impeller thrust element that is applied toward a front surface of the air-compression impeller due to rotation of the air-compression impeller,

wherein the bearing wear-causing thrust reducing/compensating unit is configured to include: a thrust reducing hole module that is formed into a certain pattern to pass through at one side of the air-leak preventive chamber, emits a part of air having certain pressure which causes the second impeller thrust element to be generated at the rear surface of the air-compression impeller, and causes the bearing wear-causing thrust generated in the air compressing unit to be reduced or compensated; a thrust internal-emission guide-pipe module that is formed to pass through in a horizontal direction at one side of the air-compression stator so as to be aligned with the thrust reducing hole module and guides a part of air to flow into the air compressing unit, the air having certain pressure (air having certain pressure to generate the second impeller thrust element) which is emitted to the thrust reducing hole module; and a pressure internal-emission thrust-reducing path module that is formed along a path connected from the thrust reducing hole module to the thrust internal-emission guide-pipe module when a part of air having certain pressure (air having certain pressure to generate the second impeller thrust element) which is generated at the rear surface of the air-compression impeller is emitted into the air compressing unit,

wherein pressure in the second pressure generation zone is reduced such that the bearing wear-causing thrust is reduced by guiding a part of air to be emitted into the air compressing unit along the pressure internal-emission thrust-reducing path module, the air having certain pressure (air having certain pressure to generate the second impeller thrust element) which is generated at the rear surface of the air-compression impeller due to high speed rotation of the air-compression impeller, and

wherein the axial-load supporting bearing is protected such that durability and a service life of the air compressing unit is maximized.

In the meantime, it should be understood that the terminology or the words used in claims should not be interpreted in normally or lexically sense. It should be interpreted as meaning and concept consistent with the technical idea of the present invention, based on the principle that the inventor can properly define the concept of the term in order to describe its invention in the best way.

Therefore, the embodiments described in the present specification and the configurations shown in the drawings are only the most preferred embodiments of the present invention, and not all the technical ideas of the present invention are described. Therefore, it is to be understood that various equivalents and modifications are possible.

### BRIEF DESCRIPTION OF THE DRAWINGS

The above and other objects, features and advantages of the present invention will be more apparent from the following detailed description taken in conjunction with the accompanying drawings, in which:

FIG. 1 is a diagram illustrating a configuration of an air compressing apparatus with a bearing wear-causing thrust reducing/compensating unit according to the invention;

FIG. 2A is a conceptual view illustrating the air compressing apparatus with a bearing wear-causing thrust reducing/compensating unit according to a first embodiment of the invention;

FIG. 2B is a conceptual view illustrating the air compressing apparatus with a bearing wear-causing thrust reducing/compensating unit according to a second embodiment of the invention;

FIG. 3A is a cross-sectional view schematically illustrating the air compressing apparatus with a bearing wear-causing thrust reducing/compensating unit according to a first embodiment of the invention;

FIG. 3B is a cross-sectional view schematically illustrating the air compressing apparatus with a bearing wear-causing thrust reducing/compensating unit according to a second embodiment of the invention;

FIG. 4A schematically illustrates an emission path of air by using a cross-sectional view of an embodiment of the air compressing apparatus with a bearing wear-causing thrust reducing/compensating unit according to a first embodiment of the invention;

FIG. 4B schematically illustrates an emission path of air by using a cross-sectional view of an embodiment of the air compressing apparatus with a bearing wear-causing thrust reducing/compensating unit according to a second embodiment of the invention;

FIG. 5 schematically illustrates a free body diagram (FBD) of bearing wear-causing thrust which is generated and works in the air compressing apparatus with a bearing wear-causing thrust reducing/compensating unit according to the invention;

FIG. 6A schematically illustrates conceptual views of an embodiment of the bearing wear-causing thrust reducing/compensating unit of configurational elements of the air compressing apparatus with a bearing wear-causing thrust reducing/compensating unit according to a first embodiment of the invention;

FIG. 6B schematically illustrates conceptual views of an embodiment of the bearing wear-causing thrust reducing/compensating unit of configurational elements of the air compressing apparatus with a bearing wear-causing thrust reducing/compensating unit according to a second embodiment of the invention;

FIG. 7A illustrates a surface state of a bearing after a certain period of operation of an air compressing apparatus without the bearing wear-causing thrust reducing/compensating unit (200) provided by the present inventor;

FIG. 7B illustrates a surface state of the bearing after the same period of operation of the air compressing apparatus with the bearing wear-causing thrust reducing/compensating unit (200) according to the invention as the period of the air compressing apparatus in FIG. 7A;

FIG. 8 is a flowchart schematically illustrating an overall mechanism of the air compressing apparatus (1) with a bearing wear-causing thrust reducing/compensating unit according to the invention;

FIG. 9A is a representative view of the Patent Literature 1 for the air compressing apparatus with a bearing wear-causing thrust reducing/compensating unit according to the invention; and

FIG. 9B is a representative view of the Patent Literature 2 for the air compressing apparatus with a bearing wear-causing thrust reducing/compensating unit according to the invention.

### REFERENCE SIGNS LIST

1: air compressing apparatus with bearing wear-causing thrust reducing/compensating unit
100: air compressing unit
110: air-compression housing
120: air-compression stator
130: air-compression rotor
140: air-compression shaft
150: air-compression impeller
160: axial-load supporting bearing
170: air-leak preventive chamber
200: bearing wear-causing thrust reducing/compensating unit
210: thrust reducing hole modules
210a: first thrust reducing hole module
210b: second thrust reducing hole module
210c: third thrust reducing hole module
220a: thrust external-emission guide-pipe module
220a-1: emitted-air smooth flowing curved-surface element
220b: thrust internal-emission guide-pipe module
220b-1: first thrust internal-emission guide-pipe module
220b-2: second thrust internal-emission guide-pipe module
230a: pressure external-emission thrust-reducing path module
230a′: multi-direction pressure external-emission thrust-reducing path module
230b: pressure internal-emission thrust-reducing path module
230b-1: first pressure internal-emission thrust-reducing path module
230b-2: second pressure internal-emission thrust-reducing path module
F: bearing wear-causing thrust
F1: first impeller thrust element
F2: second impeller thrust element
F3: third impeller thrust element
A1: first cross-sectional area
A2: second cross-sectional area
PZ1: first pressure generation zone
PZ2: second pressure generation zone

### DETAILED DESCRIPTION OF THE PREFERRED EMBODIMENT

Hereinafter, functions, configurations, and effects of an air compressing apparatus (1) with a bearing wear-causing thrust reducing/compensating unit according to the invention will be described in detail with reference to the accompanying drawings.

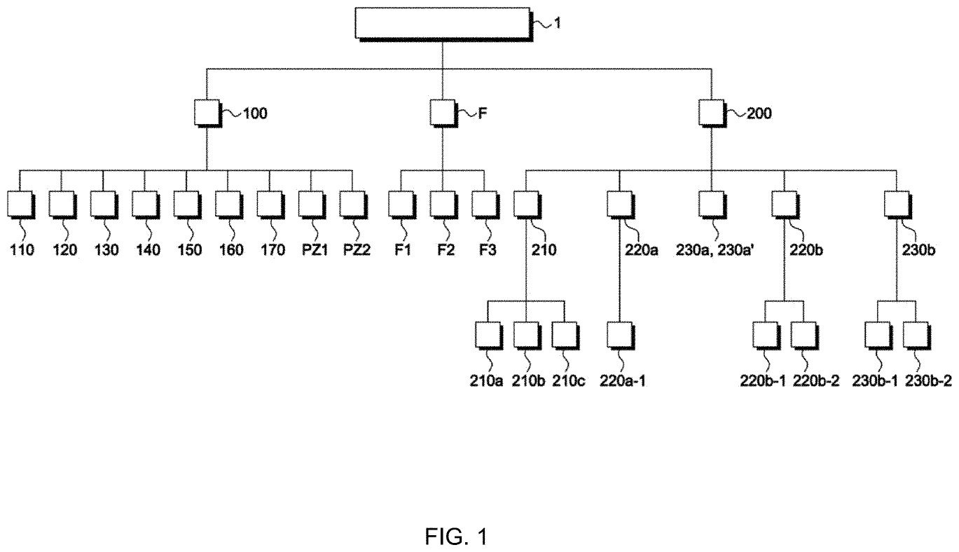

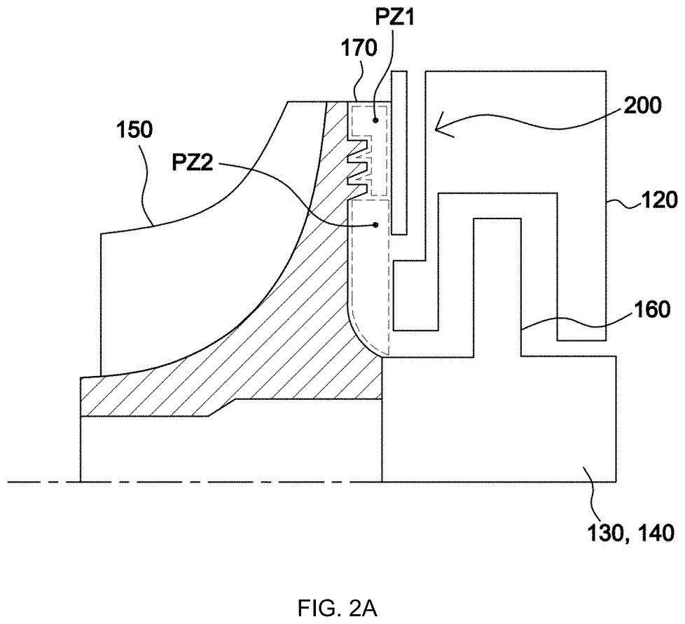

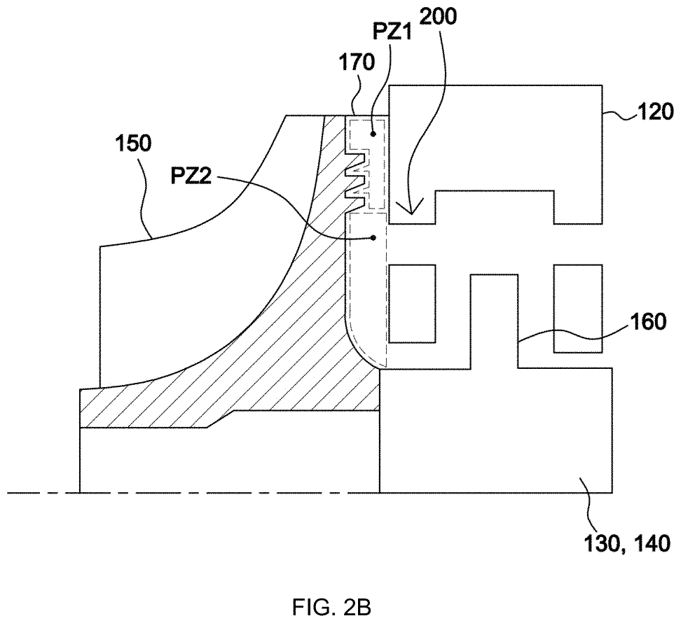

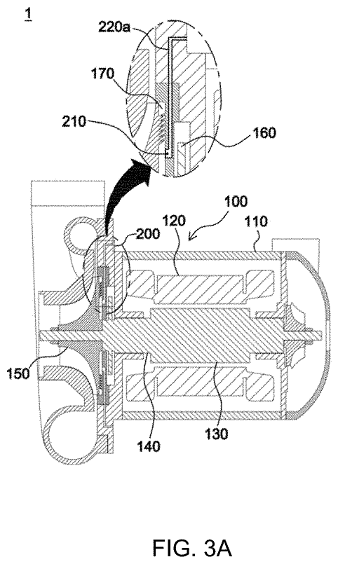

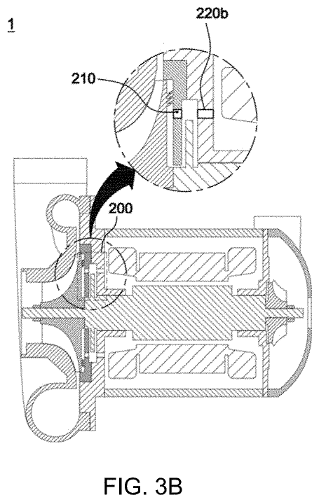

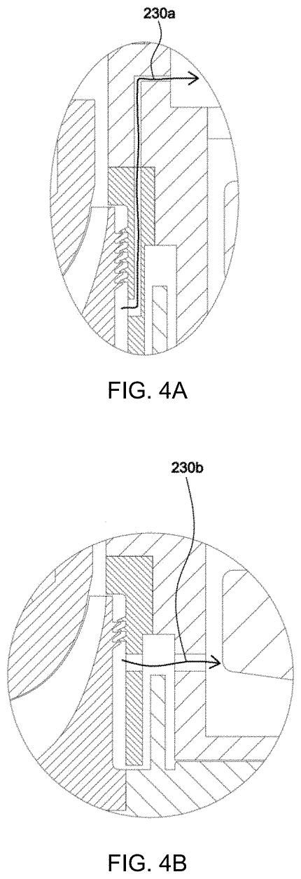

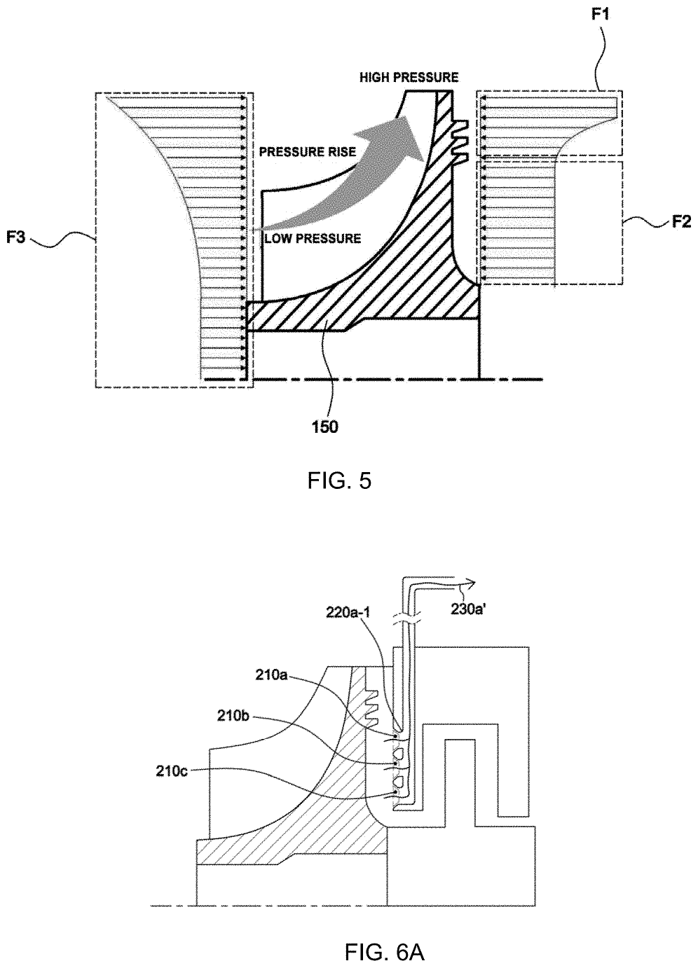

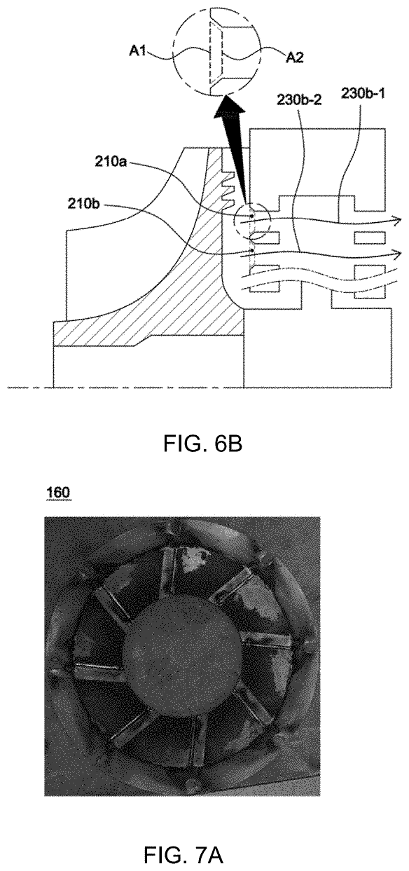

FIG. 1 is a diagram illustrating a configuration of an air compressing apparatus with a bearing wear-causing thrust reducing/compensating unit according to the invention. FIGS. 2A and 2B are conceptual views illustrating the air compressing apparatus with a bearing wear-causing thrust reducing/compensating unit according to the invention. FIGS. 3A and 3B are cross-sectional views schematically illustrating the air compressing apparatus with a bearing wear-causing thrust reducing/compensating unit according to the invention. FIGS. 4A and 4B schematically illustrate an emission path of air by using a cross-sectional view of an embodiment of the air compressing apparatus with a bearing wear-causing thrust reducing/compensating unit according to the invention. FIG. 5 schematically illustrates a free body diagram (FBD) of bearing wear-causing thrust which is generated and works in the air compressing apparatus with a bearing wear-causing thrust reducing/compensating unit according to the invention. FIGS. 6A and 6B schematically illustrate conceptual views of an embodiment of the bearing wear-causing thrust reducing/compensating unit of configurational elements of the air compressing apparatus with a bearing wear-causing thrust reducing/compensating unit according to the invention.

As illustrated in FIGS. 1 to 6B, according to a first embodiment of the invention, the air compressing apparatus (1) with a bearing wear-causing thrust reducing/compensating unit includes: an air compressing unit (100) that suctions air from outside, compresses suctioned air, and discharges compressed air; and a bearing wear-causing thrust reducing/compensating unit (200) that is formed at one side of the air compressing unit (100) and causes bearing wear-causing thrust (F) generated in the air compressing unit (100) to be reduced or compensated such that durability of the air compressing unit (100) is improved. The bearing wear-causing thrust (F) is generated in an axial direction of the air compressing unit (100) during operation of the air compressing unit (100).

The air compressing unit (100) is configured to include: an air-compression housing (110) that suctions outside air, guides the suctioned outside air to flow and be discharged, and protects, from outside, an air-compression stator (120), an air-compression rotor (130), an air-compression shaft (140), and an air-compression impeller (150) which are positioned and coupled inside the air-compression housing; the air-compression stator (120) that is a stator positioned inside the air-compression housing (110); the air-compression rotor (130) that is a rotor positioned inside the air-compression housing (110); the air-compression shaft (140) that is coupled to the air-compression rotor (130) and is rotated; the air-compression impeller (150) that is coupled to the air-compression shaft (140) and is rotated driven by rotation of the air-compression shaft (140) to suction outside air, compress suctioned outside air, and discharge compressed air; an axial-load supporting bearing (160) that is inserted into and coupled to the air-compression shaft (140) to support a load in an axial direction; and an air-leak preventive chamber (170) that is positioned between the air-compression impeller (150) and the axial-load supporting bearing (160), inhibits air from leaking through a gap between the air-compression stator (120) and the air-compression rotor (130), and reduces pressure of a rear surface of the air-compression impeller (150).

Power is generated to suction outside air, compress suctioned outside air, and discharge compressed air such that outside air is suctioned and compressed air is discharged.

The bearing wear-causing thrust (F) includes: a first impeller thrust element (F1) that is applied to a certain region at an outer side of the rear surface of the air-compression impeller (150) and is generated in a first pressure generation zone (PZ1) having high pressure generated depending on a degree of compression of air suctioned into the air compressing unit (100); a second impeller thrust element (F2) that is applied to a certain region at an inner side of the rear surface of the air-compression impeller (150) and is generated in a second pressure generation zone (PZ2) having pressure generated depending on a degree of compression of air suctioned into the air compressing unit (100); and a third impeller thrust element (F3) that is applied toward a front surface of the air-compression impeller (150) due to rotation of the air-compression impeller (150).

The bearing wear-causing thrust reducing/compensating unit (200) is configured to include: a thrust reducing hole module (210) that is formed into a certain pattern to pass through at one side of the air-leak preventive chamber (170), emits a part of air having certain pressure which causes the second impeller thrust element (F2) to be generated at the rear surface of the air-compression impeller (150), and causes the bearing wear-causing thrust (F) generated in the air compressing unit (100) to be reduced or compensated; a thrust external-emission guide-pipe module (220a) that has one end portion which matches and is connected to the thrust reducing hole module (210) and the other end portion which is formed to pass to the outside through one side of the air-compression stator (120) and that guides a part of air to be emitted to the outside, the air having certain pressure (air having certain pressure to generate the second impeller thrust element (F2)) which is emitted to the thrust reducing hole module (210); and a pressure external-emission thrust-reducing path module (230a) that is formed along a path connected from the thrust reducing hole module (210) to the thrust external-emission guide-pipe module (220a) when a part of air having certain pressure (air having certain pressure to generate the second impeller thrust element (F2)) which is generated at the rear surface of the air-compression impeller (150) is emitted outside.

Pressure in the second pressure generation zone (PZ2) is reduced such that the bearing wear-causing thrust (F) is reduced by guiding a part of air to be emitted outside along the pressure external-emission thrust-reducing path module (230a), the air having certain pressure (air having certain pressure to generate the second impeller thrust element (F2)) which is generated at the rear surface of the air-compression impeller (150) due to high speed rotation of the air-compression impeller (150).

The axial-load supporting bearing (160) is protected such that durability and a service life of the air compressing unit (100) is maximized.

According to a second embodiment, the air compressing apparatus (1) with a bearing wear-causing thrust reducing/compensating unit includes: an air compressing unit (100) that suctions air from outside, compresses suctioned air, and discharges compressed air; and a bearing wear-causing thrust reducing/compensating unit (200) that is formed at one side of the air compressing unit (100) and causes bearing wear-causing thrust (F) generated in the air compressing unit (100) to be reduced or compensated such that durability of the air compressing unit (100) is improved.

The bearing wear-causing thrust (F) is generated in an axial direction of the air compressing unit (100) during operation of the air compressing unit (100).

The air compressing unit (100) is configured to include: an air-compression housing (110) that suctions outside air, guides the suctioned outside air to flow and be discharged, and protects, from outside, an air-compression stator (120), an air-compression rotor (130), an air-compression shaft (140), and an air-compression impeller (150) which are positioned and coupled inside the air-compression housing; the air-compression stator (120) that is a stator positioned inside the air-compression housing (110); the air-compression rotor (130) that is a rotor positioned inside the air-compression housing (110); the air-compression shaft (140) that is coupled to the air-compression rotor (130) and is rotated; the air-compression impeller (150) that is coupled to the air-compression shaft (140) and is rotated driven by rotation of the air-compression shaft (140) to suction outside air, compress suctioned outside air, and discharge compressed air; an axial-load supporting bearing (160) that is inserted into and coupled to the air-compression shaft (140) to support a load in an axial direction; and an air-leak preventive chamber (170) that is positioned between the air-compression impeller (150) and the axial-load supporting bearing (160), inhibits air from leaking through a gap between the air-compression stator (120) and the air-compression rotor (130), and reduces pressure of a rear surface of the air-compression impeller (150).

Power is generated to suction outside air, compress suctioned outside air, and discharge compressed air such that outside air is suctioned and compressed air is discharged.

The bearing wear-causing thrust (F) includes: a first impeller thrust element (F1) that is applied to a certain region at an outer side of the rear surface of the air-compression impeller (150) and is generated in a first pressure generation zone (PZ1) having high pressure generated depending on a degree of compression of air suctioned into the air compressing unit (100); a second impeller thrust element (F2) that is applied to a certain region at an inner side of the rear surface of the air-compression impeller (150) and is generated in a second pressure generation zone (PZ2) having pressure generated depending on a degree of compression of air suctioned into the air compressing unit (100); and a third impeller thrust element (F3) that is applied toward a front surface of the air-compression impeller (150) due to rotation of the air-compression impeller (150).

The bearing wear-causing thrust reducing/compensating unit (200) is configured to include: a thrust reducing hole module (210) that is formed into a certain pattern to pass through at one side of the air-leak preventive chamber (170), emits a part of air having certain pressure which causes the second impeller thrust element (F2) to be generated at the rear surface of the air-compression impeller (150), and causes the bearing wear-causing thrust (F) generated in the air compressing unit (100) to be reduced or compensated; a thrust internal-emission guide-pipe module (220b) that is formed to pass through in a horizontal direction at one side of the air-compression stator (120) so as to be aligned with the thrust reducing hole module (210) and guides a part of air to flow into the air compressing unit (100), the air having certain pressure (air having certain pressure to generate the second impeller thrust element (F2)) which is emitted to the thrust reducing hole module (210); and a pressure internal-emission thrust-reducing path module (230b) that is formed along a path connected from the thrust reducing hole module (210) to the thrust internal-emission guide-pipe module (220b) when a part of air having certain pressure (air having certain pressure to generate the second impeller thrust element (F2)) which is generated at the rear surface of the air-compression impeller (150) is emitted into the air compressing unit (100).

Pressure in the second pressure generation zone (PZ2) is reduced such that the bearing wear-causing thrust (F) is reduced by guiding a part of air to be emitted into the air compressing unit (100) along the pressure internal-emission thrust-reducing path module (230b), the air having certain pressure (air having certain pressure to generate the second impeller thrust element (F2)) which is generated at the rear surface of the air-compression impeller (150) due to high speed rotation of the air-compression impeller (150).

The axial-load supporting bearing (160) is protected such that durability and a service life of the air compressing unit (100) is maximized.

In other words, the first and second embodiments of the invention are technologies of the air compressing apparatus with the bearing wear-causing thrust reducing/compensating unit (200) that emits, to outside or inside, a part of air having certain pressure (air having certain pressure to generate thrust equal to or higher than a certain threshold value) which is generated at the rear surface of the air-compression impeller (150) due to the high speed rotation of the air-compression impeller (150) so as to reduce or compensate the bearing wear-causing thrust (F) which is generated in the axial direction and works inside of the air compressing unit (100), thereby pressing the axial load supporting bearing (160) toward the rear surface of the air-compression impeller (150) due to the thrust equal to or higher than the certain threshold value to come into contact with one side of the inside of the air compressing unit (100) such that wear and friction resistance are minimized to secure a service life and durability of a bearing.

To be more specific with both the embodiments, the bearing wear-causing thrust reducing/compensating unit (200) of the first embodiment is configured to include, as described above: the thrust reducing hole module (210) that is formed into a certain pattern to pass through at one side of the air-leak preventive chamber (170), emits a part of air having certain pressure which causes the second impeller thrust element (F2) to be generated at the rear surface of the air-compression impeller (150), and causes the bearing wear-causing thrust (F) generated in the air compressing unit (100) to be reduced or compensated; the thrust external-emission guide-pipe module (220a) that has the one end portion which matches and is connected to the thrust reducing hole module (210) and the other end portion which is formed to pass to the outside through one side of the air-compression stator (120) and that guides a part of air to be emitted to the outside, the air having certain pressure (air having certain pressure to generate the second impeller thrust element (F2)) which is emitted to the thrust reducing hole module (210); and the pressure external-emission thrust-reducing path module (230a) that is formed along a path connected from the thrust reducing hole module (210) to the thrust external-emission guide-pipe module (220a) when a part of air having certain pressure (air having certain pressure to generate the second impeller thrust element (F2)) which is generated at the rear surface of the air-compression impeller (150) is emitted outside.

The pressure in the second pressure generation zone (PZ2) is reduced such that the bearing wear-causing thrust (F) is reduced by guiding a part of air to be emitted outside along the pressure external-emission thrust-reducing path module (230a), the air having certain pressure (air having certain pressure to generate the second impeller thrust element (F2)) which is generated at the rear surface of the air-compression impeller (150) due to high speed rotation of the air-compression impeller (150).

The axial-load supporting bearing (160) is protected such that durability and a service life of the air compressing unit (100) is maximized.

For example, the thrust reducing hole module (210) is formed into a trapezoidal shape in which, in accordance with a correlation (Bernoulli's principle) between a first cross-sectional area (A1) and a second cross-sectional area (A2), air is to flow more actively through the second cross-sectional area (A2), and thereby air having certain pressure generated in the second pressure generation zone (PZ2) is to be emitted to outside or inside along a specific path (refer to the enlarged view of FIG. 6B).

In other words, air flow is more smoothly performed such that air having certain pressure which causes the second impeller thrust element (F2) to be generated in the second pressure generation zone (PZ2) is to be rapidly emitted outside.

In addition, one or more thrust reducing hole modules (210) can be formed such that the air having certain pressure generated in the second pressure generation zone (PZ2) can be distributed and emitted.

In other words, a first thrust reducing hole module (210a), a second thrust reducing hole module (210b), a third thrust reducing hole module (210c), and the like can be formed such that the air having certain pressure generated in the second pressure generation zone (PZ2) can be distributed to flow into the thrust external-emission guide-pipe module (220a).

In addition, the thrust external-emission guide-pipe module (220a) is configured to further include an emitted-air smooth flowing curved-surface element (220a-1) which is formed into an arc shape at one side of an inner corner formed at an angle such that a part of the air having the certain pressure generated in the second pressure generation zone (PZ2) is more smoothly emitted outside.

In other words, Coanda effect maximizes smoothness of air flow.

In addition, as the one or more thrust reducing hole modules (210) are formed, the pressure external-emission thrust-reducing path module (230a) can be changed to a multi-direction pressure external-emission thrust-reducing path module (230a′).

The bearing wear-causing thrust reducing/compensating unit (200) of the second embodiment is configured to include, as described above: the thrust reducing hole module (210) that is formed into a certain pattern to pass through at one side of the air-leak preventive chamber (170), emits a part of air having certain pressure which causes the second impeller thrust element (F2) to be generated at the rear surface of the air-compression impeller (150), and causes the bearing wear-causing thrust (F) generated in the air compressing unit (100) to be reduced or compensated; the thrust internal-emission guide-pipe module (220b) that is formed to pass through in the horizontal direction at the one side of the air-compression stator (120) so as to be aligned with the thrust reducing hole module (210) and guides a part of air to flow into the air compressing unit (100), the air having certain pressure (air having certain pressure to generate the second impeller thrust element (F2)) which is emitted to the thrust reducing hole module (210); and the pressure internal-emission thrust-reducing path module (230b) that is formed along the path connected from the thrust reducing hole module (210) to the thrust internal-emission guide-pipe module (220b) when a part of air having certain pressure (air having certain pressure to generate the second impeller thrust element (F2)) which is generated at the rear surface of the air-compression impeller (150) is emitted into the air compressing unit (100).

The pressure in the second pressure generation zone (PZ2) is reduced such that the bearing wear-causing thrust (F) is reduced by guiding a part of air to be emitted into the air compressing unit (100) along the pressure internal-emission thrust-reducing path module (230b), the air having certain pressure (air having certain pressure to generate the second impeller thrust element (F2)) which is generated at the rear surface of the air-compression impeller (150) due to high speed rotation of the air-compression impeller (150).

The axial-load supporting bearing (160) is protected such that durability and a service life of the air compressing unit (100) is maximized.

For example, the thrust reducing hole module (210) is formed into a trapezoidal shape, similar to the first embodiment, and thereby the air having certain pressure generated in the second pressure generation zone (PZ2) is to more actively flow into the air compressing unit (100).

In other words, air flow is more smoothly performed such that the air having certain pressure generated in the second pressure generation zone (PZ2) is to more rapidly flow into the air compressing unit (100).

In addition, one or more thrust reducing hole modules (210) can be formed such that the air having certain pressure generated in the second pressure generation zone (PZ2) can be distributed to flow into the air compressing unit (100).

In other words, a first thrust reducing hole module (210a), a second thrust reducing hole module (210b), and the like can be formed such that the air having certain pressure generated in the second pressure generation zone (PZ2) can be distributed to flow into the thrust internal-emission guide-pipe module (220b).

In addition, as the one or more thrust reducing hole modules (210) are formed, the same number of the thrust internal-emission guide-pipe modules (220b) can be formed corresponding to the number of thrust reducing hole modules such that the air having certain pressure generated in the second pressure generation zone (PZ2) is distributed to flow toward one side of the inside of the air-compression housing (110), and thereby smoothness of air flow can be maximized.

In other words, a first thrust internal-emission guide-pipe module (220b-1) and a second thrust internal-emission guide-pipe module (220b-2) are formed corresponding to the first thrust reducing hole module (210a) and the second thrust reducing hole module (210b) such that the air having certain pressure generated in the second pressure generation zone (PZ2) is distributed to flow and be emitted toward the one side of the inside of the air-compression housing (110) along one or more paths.

In addition, as the one or more thrust reducing hole modules (210) and the one or more thrust internal-emission guide-pipe modules (220b) are formed, the pressure internal-emission thrust-reducing path module (230b) can be also formed to include a first pressure internal-emission thrust-reducing path module (230b-1), a second pressure internal-emission thrust-reducing path module (230b-2), and the like.

In addition, the thrust internal-emission guide-pipe module (220b) can be formed into a Venturi shape such that air flow can be more maximized due to the Venturi effect.

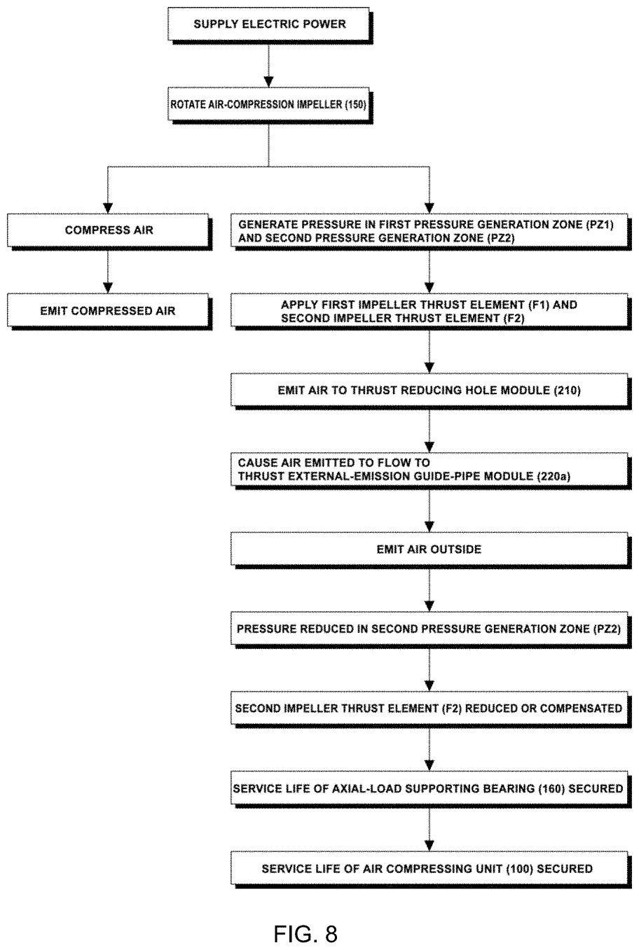

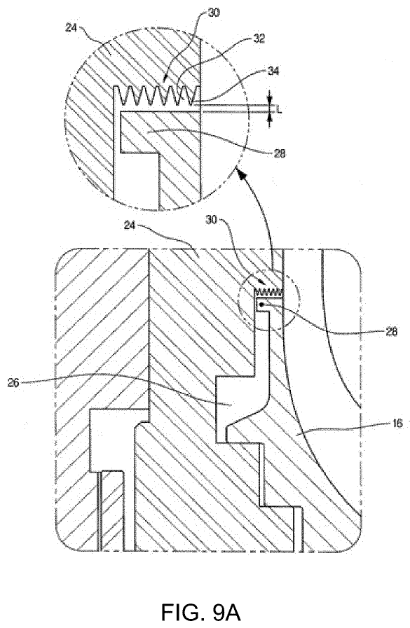

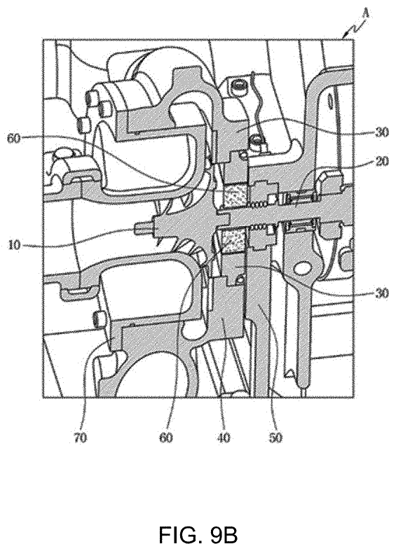

Meanwhile, FIG. 8 is a flowchart schematically illustrating an overall mechanism of the air compressing apparatus (1) with a bearing wear-causing thrust reducing/compensating unit according to the invention (mechanism according to the first embodiment).

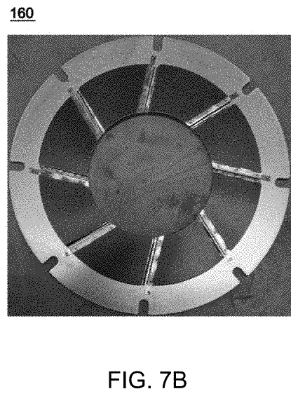

FIGS. 7A and 7B are comparison views illustrating axial-load supporting bearings of the configurational elements of the air compressing apparatus with a bearing wear-causing thrust reducing/compensating unit according to the invention.

FIG. 7A illustrates a surface state of a bearing after a certain period of operation of an air compressing apparatus without the bearing wear-causing thrust reducing/compensating unit (200) provided by the present inventor, and FIG. 7B illustrates a surface state of the bearing after the same period of operation of the air compressing apparatus (1) with the bearing wear-causing thrust reducing/compensating unit (200) according to the invention as the period of the air compressing apparatus in FIG. 7A.

In other words, the present invention is a technology for securing a service life and durability of the axial-load supporting bearing (160) formed in the air compressing unit (100) by reducing or compensating the bearing wear-causing thrust (F) generated in the axial direction of the air compressing unit (100) due to the rotation of the air-compression impeller (150).

In particular, according to the invention, when ‘F’ represents the bearing wear-causing thrust, ‘F1’ represents the first impeller thrust element, ‘F2’ represents the second impeller thrust element, and ‘F3’ represents the third impeller thrust element, the thrust can be defined by the following equation.

F=F1+F2+F3

Here, according to the invention, ‘F2’, that is, the second impeller thrust element (F2), is reduced or compensated by the bearing wear-causing thrust reducing/compensating unit (200), thereby the bearing wear-causing thrust (F) is reduced and the occurrence of a phenomenon in which the axial-load supporting bearing (160) is rubbed toward the rear surface of the air-compression impeller (150) is remarkably reduced such that the service life and durability of the axial-load supporting bearing (160) are secured.

In other words, the invention is to provide the air compressing apparatus that maximizes the service life and durability of the axial-load supporting bearing (160), further, the service life and durability of the air-compression rotor (130), and eventually the service life and durability of the air compressing unit (100), by reducing or compensating the second impeller thrust element (F2) which is one of main component forces of the bearing wear-causing thrust (F).

The bearing wear-causing thrust (F) in the invention is a force necessary for the air compressing unit (100).

In other words, when the bearing wear-causing thrust (F) is generated in the air compressing unit (100), the axial-load supporting bearing (160) can fulfill functions thereof.

In other words, the bearing wear-causing thrust (F) forms an oil film at the axial-load supporting bearing (160) such that the axial-load supporting bearing (160) can fulfill the functions thereof.

However, when the bearing wear-causing thrust (F) much higher than a certain threshold value is generated, the oil film is formed out of balance or unstably at the axial-load supporting bearing (160), and the axial-load supporting bearing caused to move toward the rear surface of the air-compression impeller (150) and be rubbed against the rear surface.

The axial-load supporting bearing (160) is rubbed against the rear surface of the air-compression impeller (150) due to the bearing wear-causing thrust (F), and thereby the axial-load supporting bearing (160) is caused to wear and be damaged. Hence, the service life of the axial-load supporting bearing (160) is remarkably reduced, and the reduction in service life of the axial-load supporting bearing (160) results in a reduction in service life of the air-compression rotor (130). In addition, the reduction in service life of the air-compression rotor (130) means a reduction in service life of the air compressing unit (100), and thus the service life and durability of the axial-load supporting bearing (160) needs to be secured.

Consequently, the bearing wear-causing thrust (F) needs to be reduced or compensated such that appropriate bearing wear-causing thrust (F) is generated in the air compressing unit (100).

This is because the bearing wear-causing thrust (F) which is generated in the air compressing unit (100) is difficult to accurately estimate. Thus, a solution for reducing or compensating the bearing wear-causing thrust (F) which is unavoidably generated in the air compressing unit (100) needs to be provided.

Hence, in the invention, the service life and durability of the axial-load supporting bearing (160) is to be secured by reducing or compensating the bearing wear-causing thrust (F) generated in the air compressing unit (100) by the bearing wear-causing thrust reducing/compensating unit (200).

As described above in the description of configurations and effects, according to the invention, 1. thrust generated in an air compressing unit is reduced or compensated such that a service life and durability of the air compressing unit are maximized.

In other words, thrust is to be reduced or compensated by emitting, to outside or inside, a part of air having certain pressure which causes thrust to be generated inside the air compressing unit and reducing pressure generated at one side of a rear surface of an air-compression impeller such that movement of a bearing positioned at the one side of the rear surface of the air-compression impeller toward the rear surface of the air-compression impeller and rubbing of the bearing against the rear surface due to the thrust equal to or higher than a certain threshold value is minimized or inhibited.

In other words, the bearing is protected and the service life and the durability of the air compressing apparatus are to be maximized by minimizing or inhibiting wear and friction resistance, and cracks and damage therefrom, of the bearing due to the thrust equal to or higher than the threshold value.

2. Thrust can be reduced or compensated to secure a service life and durability of the bearing, in cooperation with the air-leak preventive chamber that reduces pressure of the rear surface of the air-compression impeller.

3. The thrust is reduced or compensated, and thereby a loss of energy is reduced such that efficiency of energy is improved. In other words, the invention is very effective in that thrust which is generated and works in the air compressing unit is reduced or compensated and wear and friction resistance of the bearing is minimized such that the service life and the durability of the bearing are secured.

It will be apparent to those skilled in the art that various modifications and variations can be made in the present invention without departing from the spirit or scope of the invention as defined in the appended claims.

This invention can be implemented in many different forms without departing from technical aspects or main features. Therefore, the implementation examples of this invention are nothing more than simple examples in all respects and will not be interpreted restrictively.

### INDUSTRIAL APPLICABILITY

The present invention relates to an air compressing apparatus with a bearing wear-causing thrust reducing/compensating unit, it can be applied to a manufacturing and sales business of manufacturing them, and it can contribute to an improvement in general industrial sites where air compression means are utilized and various industrial fields in which blowers and compressors are used.

What is claimed is:

1. An air compressing apparatus (1) with a bearing wear-causing thrust reducing/compensating unit, the air compressing apparatus comprising:
an air compressing unit (100) that suctions air from outside, compresses suctioned air, and discharges compressed air; and
a bearing wear-causing thrust reducing/compensating unit (200) that is formed at one side of the air compressing unit (100) and causes bearing wear-causing thrust (F) generated in the air compressing unit (100) to be reduced or compensated such that durability of the air compressing unit (100) is improved,
wherein the bearing wear-causing thrust (F) is generated in an axial direction of the air compressing unit (100) during operation of the air compressing unit (100),
wherein the air compressing unit (100) is configured to include:
an air-compression housing (110) that suctions outside air, guides the suctioned outside air to flow and be discharged, and protects, from outside, an air-compression stator (120), an air-compression rotor (130), an air-compression shaft (140), and an air-compression impeller (150) which are positioned and coupled inside the air-compression housing;
the air-compression stator (120) that is a stator positioned inside the air-compression housing (110);
the air-compression rotor (130) that is a rotor positioned inside the air-compression housing (110);
the air-compression shaft (140) that is coupled to the air-compression rotor (130) and is rotated;
the air-compression impeller (150) that is coupled to the air-compression shaft (140) and is rotated driven by rotation of the air-compression shaft (140) to suction outside air, compress suctioned outside air, and discharge compressed air;
an axial-load supporting bearing (160) that is inserted into and coupled to the air-compression shaft (140) to support a load in an axial direction; and
an air-leak preventive chamber (170) that is positioned between the air-compression impeller (150) and the axial-load supporting bearing (160), inhibits air from leaking through a gap between the air-compression stator (120) and the air-compression rotor (130), and reduces pressure of a rear surface of the air-compression impeller (150),
wherein power is generated to suction outside air, compress suctioned outside air, and discharge compressed air such that outside air is suctioned and compressed air is discharged,
wherein the bearing wear-causing thrust (F) includes:
a first impeller thrust element (F1) that is applied to a certain region at an outer side of the rear surface of the air-compression impeller (150) and is generated in a first pressure generation zone (PZ1) having high pressure generated depending on a degree of compression of air suctioned into the air compressing unit (100);
a second impeller thrust element (F2) that is applied to a certain region at an inner side of the rear surface of the air-compression impeller (150) and is generated in a second pressure generation zone (PZ2) having pressure generated depending on a degree of compression of air suctioned into the air compressing unit (100); and
a third impeller thrust element (F3) that is applied toward a front surface of the air-compression impeller (150) due to rotation of the air-compression impeller (150),
wherein the bearing wear-causing thrust reducing/compensating unit (200) is configured to include:
a thrust reducing hole module (210) that is formed into a certain pattern to pass through at one side of the air-leak preventive chamber (170), emits a part of air having certain pressure which causes the second impeller thrust element (F2) to be generated at the rear surface of the air-compression impeller (150), and causes the bearing wear-causing thrust (F) generated in the air compressing unit (100) to be reduced or compensated;
a thrust external-emission guide-pipe module (220a) that has one end portion which matches and is connected to the thrust reducing hole module (210) and the other end portion which is formed to pass to the outside through one side of the air-compression stator (120) and that guides a part of air to be emitted to the outside, the air having certain pressure (air having certain pressure to generate the second impeller thrust element (F2)) which is emitted to the thrust reducing hole module (210); and
a pressure external-emission thrust-reducing path module (230a) that is formed along a path connected from the thrust reducing hole module (210) to the thrust external-emission guide-pipe module (220) when a part of air having certain pressure (air having certain pressure to generate the second impeller thrust element (F2)) which is generated at the rear surface of the air-compression impeller (150) is emitted outside,
wherein pressure in the second pressure generation zone (PZ2) is reduced such that the bearing wear-causing thrust (F) is reduced by guiding a part of air to be emitted to the outside along the pressure external-emission thrust-reducing path module (230a), the air having certain pressure (air having certain pressure to generate the second impeller thrust element (F2)) which is generated at the rear surface of the air-compression impeller (150) due to high speed rotation of the air-compression impeller (150), and
wherein the axial-load supporting bearing (160) is protected such that durability and a service life of the air compressing unit (100) is maximized.

2. An air compressing apparatus (1) with a bearing wear-causing thrust reducing/compensating unit, the air compressing apparatus comprising:
an air compressing unit (100) that suctions air from outside, compresses suctioned air, and discharges compressed air; and
a bearing wear-causing thrust reducing/compensating unit (200) that is formed at one side of the air compressing unit (100) and causes bearing wear-causing thrust (F) generated in the air compressing unit (100) to be reduced or compensated such that durability of the air compressing unit (100) is improved,
wherein the bearing wear-causing thrust (F) is generated in an axial direction of the air compressing unit (100) during operation of the air compressing unit (100),
wherein the air compressing unit (100) is configured to include:
an air-compression housing (110) that suctions outside air, guides the suctioned outside air to flow and be discharged, and protects, from outside, an air-compression stator (120), an air-compression rotor (130), an air-compression shaft (140), and an air-compression impeller (150) which are positioned and coupled inside the air-compression housing;
the air-compression stator (120) that is a stator positioned inside the air-compression housing (110);
the air-compression rotor (130) that is a rotor positioned inside the air-compression housing (110);
the air-compression shaft (140) that is coupled to the air-compression rotor (130) and is rotated;
the air-compression impeller (150) that is coupled to the air-compression shaft (140) and is rotated driven by rotation of the air-compression shaft (140) to suction outside air, compress suctioned outside air, and discharge compressed air;
an axial-load supporting bearing (160) that is inserted into and coupled to the air-compression shaft (140) to support a load in an axial direction; and
an air-leak preventive chamber (170) that is positioned between the air-compression impeller (150) and the axial-load supporting bearing (160), inhibits air from leaking through a gap between the air-compression stator (120) and the air-compression rotor (130), and reduces pressure of a rear surface of the air-compression impeller (150),
wherein power is generated to suction outside air, compress suctioned outside air, and discharge compressed air such that outside air is suctioned and compressed air is discharged,
wherein the bearing wear-causing thrust (F) includes:
a first impeller thrust element (F1) that is applied to a certain region at an outer side of the rear surface of the air-compression impeller (150) and is generated in a first pressure generation zone (PZ1) having high pressure generated depending on a degree of compression of air suctioned into the air compressing unit (100);
a second impeller thrust element (F2) that is applied to a certain region at an inner side of the rear surface of the air-compression impeller (150) and is generated in a second pressure generation zone (PZ2) having pressure generated depending on a degree of compression of air suctioned into the air compressing unit (100); and
a third impeller thrust element (F3) that is applied toward a front surface of the air-compression impeller (150) due to rotation of the air-compression impeller (150),
wherein the bearing wear-causing thrust reducing/compensating unit (200) is configured to include:
a thrust reducing hole module (210) that is formed into a certain pattern to pass through at one side of the air-leak preventive chamber (170), emits a part of air having certain pressure which causes the second impeller thrust element (F2) to be generated at the rear surface of the air-compression impeller (150), and causes the bearing wear-causing thrust (F) generated in the air compressing unit (100) to be reduced or compensated;
a thrust internal-emission guide-pipe module (220b) that is formed to pass through in a horizontal direction at one side of the air-compression stator (120) so as to be aligned with the thrust reducing hole module (210) and guides a part of air to flow into the air compressing unit (100), the air having certain pressure (air having certain pressure to generate the second impeller thrust element (F2)) which is emitted to the thrust reducing hole module (210); and
a pressure internal-emission thrust-reducing path module (230b) that is formed along a path connected from the thrust reducing hole module (210) to the thrust internal-emission guide-pipe module (220b) when a part of air having certain pressure (air having certain pressure to generate the second impeller thrust element (F2)) which is generated at the rear surface of the air-compression impeller (150) is emitted into the air compressing unit (100),
wherein pressure in the second pressure generation zone (PZ2) is reduced such that the bearing wear-causing thrust (F) is reduced by guiding a part of air to be emitted into the air compressing unit (100) along the pressure internal-emission thrust-reducing path module (230b), the air having certain pressure (air having certain pressure to generate the second impeller thrust element (F2)) which is generated at the rear surface of the air-compression impeller (150) due to high speed rotation of the air-compression impeller (150), and
wherein the axial-load supporting bearing (160) is protected such that durability and a service life of the air compressing unit (100) is maximized.
